(19) United States
(12) Patent Application Publication
(10) Pub. No.: US 2007/0010147 A1
(43) Pub. Date: Jan. 11, 2007

(54) Flexible glass fiber weave

(76) Inventor: Paul G. Swiszcz, Niwot, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/582,187

(22) PCT Filed: Feb. 23, 2005
(86) PCT No.: PCT/US05/05677

§ 371 Date: Jun. 8, 2006

Related U.S. Application Data
(60) Provisional application No. 60/547,644, filed on Feb. 24, 2004.

(51) Int. Cl. D04H 1/00; B32B 27/04; D04H 3/00

(52) U.S. Cl. 442/38; 442/50; 442/54; 442/58; 442/20

(57) ABSTRACT

A flexible glass fiber woven product characterized by, among other features, stability in three dimensions (namely horizontal, lateral, and vertical, as well as combinations thereof), resistance to tearing or cutting, flat surface, and a relative thinness when compared to other fiber weaves. The fiber weave may, for example, be utilized as a window screen, window or door covering, mat, and so forth.

### BACKGROUND OF THE INVENTION

1. Technical Field

The invention relates generally to a flexible glass fiber weave, and more specifically to a mesh or lattice made of flexible, polymer-coated fiberglass yarns.

2. Background Art

Roller blinds are often used to cover windows, especially in commercial buildings (such as offices or restaurants) where economic factors, rather than aesthetics, may strongly dictate building and finishing materials. Roller blinds, for example, generally excel at minimizing light through a window or other architectural opening and efficiently blocking heat transfer, while simultaneously being relatively inexpensive to install. Different roller blinds may also provide varying levels of privacy and opacity, simply by varying the density of the fabric weave. Denser fabric weaves are both more opaque and private, while weaves having greater spacing between individual fibers are less opaque, easier to see through, and generally permit greater heat transfer between sides of the weave.

The commercial roller blind industry is generally dominated by “woven screen” roller blinds. The term “woven screen,” in this context, generally refers to a grid or mesh formed of a first series of polyvinylchloride-(PVC) coated, fiberglass yarns crossing a second series of PVC-coated, fiberglass yarns at substantially right angles. The fiberglass yarns are typically coated with PVC, then subjected to high heat to bond yarns crossing one another together. The first and second series of yarns may simply overlay each other, or individual yarns in each series may be woven over and under yarns in the opposing series.

Generally, fiberglass yarns are used to make woven screens in order to impart dimensional stability, minimize elongation of the screen due to stresses placed thereon, and minimize flammability. The PVC coating may enhance each yarn (and the overall weave itself) by providing fusibility as described above, resistance to rotting, ultraviolet stability, and resistance to flame, all at a relatively low cost.

Presently, many European countries seek to eliminate PVC from woven screens and roller blinds, since PVC may release toxic gases or chemicals when on fire. In the United States, many consumers who are looking for an aesthetically pleasing roller screen have little or no choice, other than the “industrial” look provided by current woven screens.

In addition to the possible toxicity during fires and lack of aesthetic appeal, PVC coated yarns, or other PVC coated fabrics, often have other shortcomings. For example, PVC coated fabrics are expensive relative to non-coated fabrics. PVC coated yarns and/or fabrics are generally thicker and heavier than non-coated fabrics. This, in turn, increases both the weight and diameter of a fabric roll (also referred to as the “roll-up diameter”).

Accordingly, there is a need in the art for an improved flexible fiberglass woven screen.

### SUMMARY OF THE INVENTION

Generally, one embodiment of the present invention may take the form of a flexible glass fiber weave. The flexible glass fiber weave is generally characterized by, among other features, stability in three dimensions (namely horizontal, lateral, and vertical, as well as combinations thereof), resistance to tearing or cutting, flat surface, and a relative thinness when compared to other fiber weaves. The fiber weave may, for example, be utilized as a window screen, window, or other architectural opening, door covering, mat, and so forth.

The flexible glass fiber weave is typically laminated with a polymer sheet, web, or other form of polymer. For example, the flexible fiber weave may include a first fiberglass yarn series, a second fiberglass yarn series bonded to the first fiberglass yarn series, and a polymer dry-lay bonded to a top surface of at least one of the series of first and second fiberglass yarns. A “dry-lay” bond colloquially refers to a bond between two materials or items created without use of liquids, such as chemical baths or dips. “Liquids” here refers to compositions that maintain a liquid form at normal room temperatures, rather than compositions or elements that may be melted at high temperatures. An adhesive may optionally be employed to bond the polymer sheet to the series of fiberglass yarns or the flexible weave.

One embodiment of the present invention may be manufactured by placing a polymer sheet on a first surface of a flexible weave, the flexible weave comprising at least one yarn, heating the combination of polymer sheet and flexible weave to a melting point, bonding the polymer sheet to the flexible weave to form a flexible laminated weave, and cooling the flexible laminated weave. Generally, the melting point referred to herein is either the melting point of an adhesive used to bond the polymer sheet to the flexible weave, if present, or the melting point of the polymer sheet itself, if not. If an adhesive is used, the adhesive creates the bond between polymer and weave. Otherwise, the polymer is heated until it melts and at least partially encapsulates the yarns of the fiber weave, thus creating the aforementioned bond.

Additional advantages and improvements inherent in the embodiment will be apparent to those of ordinary skill in the art upon reading the disclosure, below.

### BRIEF DESCRIPTION OF THE FIGURES

FIG. 1 depicts an exploded view of a first embodiment of a polymer-coated fiber weave.

FIG. 2 depicts the polymer-coated fiber weave of FIG. 1, with the polymer partially filling void spaces within the weave.

FIG. 3 depicts an exploded view of a second polymer-coated fiber weave, in accordance with a second embodiment of the present invention.

FIG. 4 depicts an exemplary fiber weave.

FIG. 5 is a flowchart depicting a method of manufacturing an embodiment of the present invention.

### DETAILED DESCRIPTION OF THE INVENTION

1. General Description of the Preferred Embodiments.

Generally, the product of the present invention takes the form of a flexible glass fiber weave. The flexible glass fiber weave is generally characterized by, among other features, stability in three dimensions (namely horizontal, lateral, and vertical, as well as combinations thereof), resistance to tearing or cutting, flat surface, and a relative thinness when compared to other fiber weaves. The fiber weave may, for example, be utilized as a window screen, window, or other architectural opening, door covering, mat, and so forth.

The product is generally dimensionally stable, thinner, and less expensive than many commercially available equivalent materials. Dimensional stability is obtained, for example, by laminating one or more thermoplastic materials (which may come in one or more forms, such as particulate, solid sheet, set of strips, or woven fabric) to a surface of a woven fiberglass scrim. The overall manufacturing process, as well as the cost of the scrim itself, contributes to the minimal cost of the finished product. Similarly, the manufacturing process renders the finished product substantially flat and uniform in either lateral or longitudinal cross-section, while maintaining an overall thinness.

It should be noted a thermoset resin, such as a polyacrylic acid, may be used in place of the thermoplastic material. Accordingly, all references to a thermoplastic material herein should be understood to embrace a thermoset resin.

2. The Three-Layer Embodiment

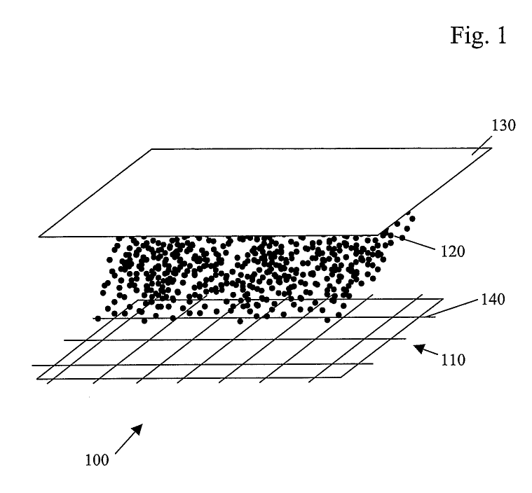

FIG. 1 depicts an exploded view of a first embodiment 100 of a three layer coated fiberglass weave. As may be seen, the embodiment 100 generally includes three separate layers, namely a fiberglass weave (or “scrim”) 110, an adhesive 120, and a polymer sheet 130. In this embodiment 100, the polymer sheet 130 is generally contiguous, lacking holes or discontinuities therein. The individual yarns 140 of the fiberglass weave 110 may be interwoven such that each yarn is placed atop a first perpendicular yarn, under a second, adjacent perpendicular yarn, and so on, alternating along the weave 100. Alternately, all parallel yarns 140 may be generally co-planar along their length with one another, such that all horizontally-running yarns lie either above or below all vertically-running yarns. In either case, overlying or otherwise touching fiberglass yarns are typically heat-bonded to one another, although chemical bonds (such as adhesives), sonically-welded bonds, and so forth may join overlapping yarns 140 in alternative embodiments.

It should be noted that the distance or spacing between adjacent yarns 140 may vary without affecting the manufacture or operation of the embodiment 100, except where specified otherwise. In some embodiments, the spacing between adjacent yarns 140 may deliberately vary, in order to create a desired appearance or function.

Generally, all yarns 140 in the present embodiment are flat in lateral cross section, rather than circular. Similarly, the yarns 140 are substantially uniform in longitudinal cross-section, no matter the distance from the edge at which the cross-section is taken. Further, the yarn thickness generally does not substantially vary along the yarn's length, and each yarn in the weave 100 has generally equal dimensions. For example, the overall thickness of each yarn 140 in the present embodiment 100 is preferably approximately 0.006 to 0.010 inches, although this thickness range may vary in alternative embodiments. Alternative embodiments may also employ yarns of varying dimensions, circular lateral cross-section, and so forth.

Additionally, alternate embodiments may employ yarns 140 of materials other than fiberglass. For example, KEVLAR, carbon fiber, cotton, and various polyesters may all make yarns suitable for incorporation into weaves 110.

The adhesive 120 may be any type of commercially-suitable adhesive capable of bonding a polymer to the fiberglass weave, such as a hot-melt. One suitable hot-melt is EMS 1533.

Further, although the adhesive 120 is shown in FIG. 1 in a particulate form, alternate embodiments may employ adhesives in different forms. For example, one embodiment may use a liquid glue capable of withstanding high temperatures during the bonding process described below, while another may employ a sheet or film of solid adhesive 120. Generally, the adhesive facilitates bonding the polymer sheet 130 to the fiberglass weave 110, or more specifically to the yarns 140 in the fiberglass weave. As the separate layers are heated during the manufacturing process (described below), the hot-melt adhesive 120 melts, flowing across the top surface of the fiberglass weave 110, and filling void spaces between yarns 140. The adhesive 120 further flows and coats the underside of the polymer sheet 130. Once the adhesive sets, the polymer sheet 130 and weave 110 are bonded to one another.

The third layer of the present embodiment 100 is the polymer sheet 130. The sheet's composition may vary, depending on the desired properties of the embodiment 100. For example, the polymer sheet 130 may be a polyester dry-lay, non-woven sheet having approximately 16-26 grams/square meter (GSM) of thermoplastic, in order to provide ultraviolet- and infrared-resistant properties. The sheet 130 may include woven fibers or other material to create a moire pattern, a gravure, or may have another pattern for visual appeal. The composition and properties of the sheet 130, accordingly, may determine many characteristics of the final embodiment 100. For example, if the polymer sheet 130 is translucent, the embodiment 100 is also generally translucent. Similarly, the embodiment may be rendered opaque, transparent, or reflective by choosing the appropriate polymer sheet 130 for bonding to the fiberglass weave 110.

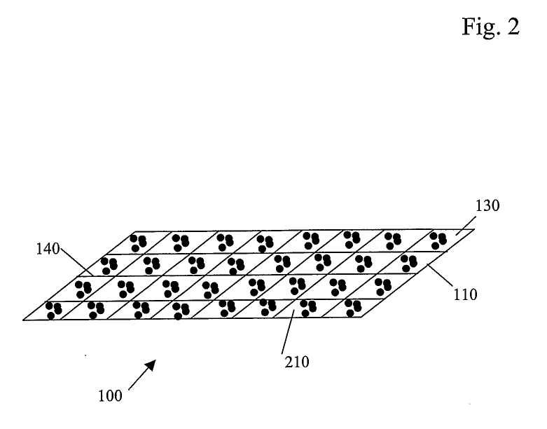

FIG. 2 depicts the embodiment 100 of FIG. 1 with the polymer bonded to the weave 110. As shown, the polymer sheet 130 generally sits upon the fiber weave 110, with the adhesive 120 bonding the two and filling void spaces 210 between yarns 140 in the scrim.

When assembled, the combination of layers 110, 120, 130 imparts structural strength, dimensional stability, and resistance to cracking or folding to the embodiment 100. In general, the addition of the laminated thermoplastic material (i.e., the polymer sheet 130) gives the fiberglass scrim a more flexible character. Rather than cracking or creasing when folded. The embodiment 100 will resist folding and recover without a crease line or mark. The thermoplastic encapsulating the fiberglass yarns 140 minimizes permanent deformation of the yarns; the inherent resilience of the thermoplastic facilitates recovery of the yarns 140 to their original shape after being folded or otherwise subjected to stresses or loads.

Further, the manufacturing process may heat the polymer material of the sheet 130 sufficiently to cause it to partially melt and flow, in addition to the adhesive 120. As the polymer material flows into the scrim 110, it typically envelops the fiberglass yarns 140. This encapsulation renders the fiberglass yarns 140 (and thus the entire embodiment 100) more stable. Encapsulating the yarns 140 with polymer 130 minimizes surface discontinuities, such as rough edges or splinters that may otherwise be present on raw fiberglass yarn fibers 140. Accordingly, the embodiment 100 generally has a relatively smooth finish, although the finish may be varied by changing the thickness of the polymer sheet 130 or characteristics of the sheet. Further, the polymer 130 adds little to no thickness to the overall embodiment 100, since it may melt into and around the fiberglass yarns 140.

It should be noted that melting of the polymer sheet 130 is entirely optional. In some embodiments, the polymer sheet 130 may be melted in order to encapsulate individual yarns 140. In alternate embodiments, the polymer sheet 130 may remain in its initial, whole state and be bonded to the weave 110 entirely by the adhesive 120. Even where the polymer sheet 130 simply lies atop the weave 110 and is bonded thereto, the polymer generally prevents individual yarns 140 from bending sufficiently far to crease or crack. The resilience of the polymer 130, even where the polymer does not encapsulate the weave 110, is adequate to minimize deformation of the yarns 140 and, thus, the embodiment 100.

3. The Two-Layer Embodiment

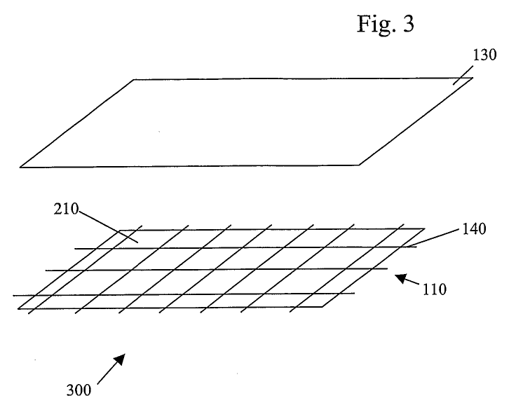

Some embodiments 300, such as shown in the exploded view of FIG. 3, may omit the adhesive layer 120 entirely. In such embodiments 300, the polymer sheet 130 is generally made of a thermoplastic or other material having a relatively low melting point, such as a polyester, polypropylene, or polyolefin. In these embodiments 300, the polymer sheet 130 generally melts during the manufacturing process and encapsulates individual yarns 140 in the fiberglass weave 110, as described above. As the polymer melts and encapsulates the yarns, capillary action draws the polymer into the interior of each gap between adjacent yarns, thus filling in all void spaces 210 defined by the yarns 140 as well. Because the glass fibers 140 have minimal thermal mass, the air inside each void space 210 is typically heated to a temperature higher than that of the surrounding yarns. Accordingly, the capillarity of the polymer is enhanced, drawing the polymer further into the void space and away from the yarns 140. This, in turn, facilitates filling in the entirety of each void space 210 with polymer. At the same time, the polymer flows over the various surfaces of the yarns 140, thus coating all sides of the yarns (including the side of the weave 110 initially opposite the polymer sheet 130). Eventually, the polymer is distributed not only within the void spaces 210 and across the top surface of the weave 110, but also across the bottom surface. In this manner, the entirety of the weave 110 may be encapsulated by polymer, thus providing a uniform feel, finish, and quality to the final embodiment 300. The wicking of the polymer into the void spaces 210 may be controlled by varying the manufacturing temperature. This may permit alternate embodiments to only partially encapsulate yarns 140, for example, by employing slow capillary action through minimal heating, then terminating the process before the polymer 130 fully encapsulates the weave 110 and individual yarns 140 therein.

4. The Fiber Weave

The fiber weave 410 may be made from a variety of yarns 412. In one embodiment 400, flat yarns of pure fiberglass may be used. The yarns 412 may be coated with a resin, such as melamine, to enhance the weave's dimensional stability and handling characteristics. Essentially, the resin coating minimizes shifting or movement of the yarns 412 with respect to one another, enhancing the bonding between overlapping yarns.

The fiberglass weave 410 may include a variety of other coatings applied to the yarns 412, such as a coloring. The yarns 412, for example, may be dyed, painted, or otherwise coated with any desired colors without affecting the manufacture or operation of the embodiment 400. Generally, such colors are added during the finishing bath applied to the weave 410. The thickness of the final weave 410, regardless of coloring, coating, and other treatments applied thereto, is generally between 0.006 and 0.010 inches.

Further, the weave or scrim's 410 woven pattern may be varied quite substantially. When selecting a scrim pattern, several factors may be considered. First, the capillary action of the weave may play a factor, to ensure the entirety of each yarn 412 is adequately coated and the void space 414 completely filled (if desired). If the yarns 412 are placed too far apart, for example, the polymer 130 may not fill the entirety of the void spaces 414.

Additionally, varying the weave of the scrim 410 may considerably affect the embodiment's 400 aesthetic, especially when a translucent or transparent polymer sheet 130 is used, permitting the weave to show. The weave may mimic, for example, the appearance of a woven wood blind by employing a warp of fine, narrow yarns 412 and wide, flat fill yarns. The narrow and wide yarns may alternate to create the woven wood look. Further, introducing variations in the width of yarns 412 and/or slightly shifting the yarns 412 with respect to one another along their length may impart an organic aesthetic. Similarly, a more traditional, woven cloth look may be created by using a weave 410 having yarns 412 placed close to one another, with minimal void spaces 414 between. Such weaves 410 generally have yarns 412 of relatively uniform thickness, both when measured along a yarn's individual length and when compared to other yarns in the weave. As yet another example, employing fine yarns 412 having a small cross-sectional area, and spacing these yarns sufficiently far apart that the void spaces 414 in between are visible to the naked eye, may create the illusion that the glass serves as a structure reinforcing the polymer sheet 130 or other element bonded thereto.

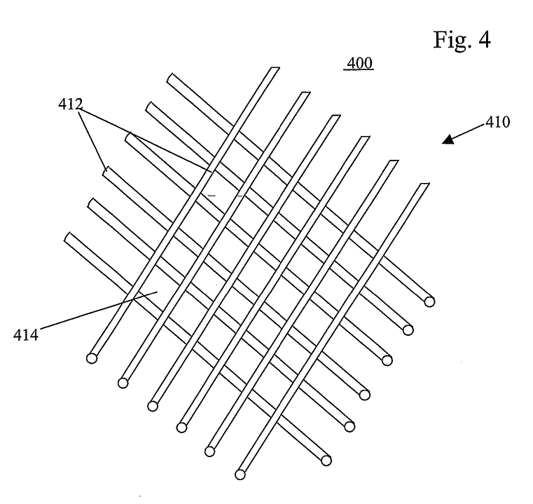

Although the weave shown in FIG. 4 depicts all yarns 412 running in a given direction as overlaying all yarns running in a second direction, alternate embodiments of the weave may interlace yarns, reverse the overlay direction, or employ some combination thereof.

5. Additional Laminates

In addition to the those described above, many additional effects may be present in other embodiments of the present invention. Effects may be added by varying the fiberglass weave (for example, changing the dimensions or material of the yarns), the adhesive (employing a thick, semi-opaque adhesive versus a clear adhesive), or the polymer sheet (for example, by adding patterns or opacity to the polymer). Alternately, additional layers may be added to achieve specific effects. For example, a specially-prepared ultraviolet-resistant film may be added in addition to the basic layers described herein to block ultraviolet rays.

One example of an embodiment having additional effects is a woven fiberglass scrim laminated to a lightweight, carded polyester non-woven sheet. The sheet may be printed with a random dot coating of hot melt adhesive, rather than having the adhesive applied separately. A lightweight-carded polyester web dot coated with adhesive generally imparts a more traditional, non-woven surface appearance and hand to one or both sides of the woven fiberglass mat. Further, a translucent non-woven appearance also may be added. This may soften and diffuse light passing through the mat. Also, once bonded to the woven glass mat, a light or mid weight non-woven will respond to the gripping force of a VELCRO type hook material.

Another example of an embodiment having additional effects is a woven fiberglass weave laminated to a lightweight, hydroentangled polyester non-woven sheet previously cast coated with copolyester hot melt. In the case of the hydroentangled substrate, a urethane-type adhesive is bonded thereto, imparting certain qualities. Since the substrate is continuous after bonding, it is possible to bond the fiberglass yarns to the substrate, rendering the weave impermeable to air or liquid. Additionally, hydroentangled substrates are extremely soft in all directions, much like the urethane adhesive bonded thereon. As with the carded web mentioned above, a light- or mid-weight non-woven hydroentangled polyester sheet will also respond to the gripping force of a VELCRO type hook material. Thus, when bonded to the fiberglass weave, the resulting composite, bonded weave also accepts VELCRO hooks.

Yet another example of an embodiment having additional effects added to the weave by means of a polymer sheet is that of a woven fiberglass scrim laminated to a non-continuous, lightweight polyester polymer web. In this instance, the lightweight thermoplastic non-woven or polymer web is typically melted directly into the fiberglass scrim. This creates a unique visual appearance, in which some of the weave's void spaces are filled with polymer while some such spaces are not. Because some void spaces are filled while others remain empty, the substrate acquires a unique, frosted appearance when viewed in moderate to bright light (such as direct sunshine).

Another example of an embodiment of the present invention is that of a woven fiberglass scrim laminated to a continuous, lightweight urethane hot melt cast web. Generally, the hot melt cast web may be used in place of the polymer sheet; in some embodiments the polymer may be formed into a web instead of a sheet.

6. Manufacturing

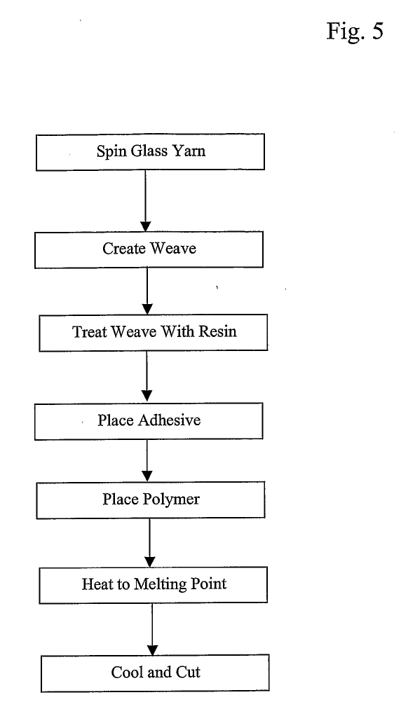

FIG. 5 is a flowchart depicting an exemplary method for manufacturing a flexible glass fiber weave. Initially, glass yarns are spun from fiberglass. Next, the weave is assembled from the individual yarns, typically via a loom. The yarns may be woven together, or may simply lay flat across one another.

As part of the assembly, the yarns are bonded together. Adjacent yarns may be heat-bonded to one another to stabilize the weave, or yarns may be bonded through a chemical reaction or adhesive. Regardless of the exact bonding mechanism, the bonded yarns generally provide stability in at least two dimensions, namely along the lateral and longitudinal axes of the weave.

Optionally, although not depicted in FIG. 5, a silane coating may be added to the yarns. The silane coating facilitates dyeing of the yarns, as well as minimizing degradation of the yarns due to stresses exerted during the manufacturing process, including removing the weave from the loom and spooling of the weave. Additionally, the silane coating added to a yarn before weaving may facilitate an organic look and feel for the yarn.

Next, a resin may be added to the weave. The resin generally enhances dimensional stability. One exemplary resin is melamine. The silane and resin coatings are entirely optional.

Next, the adhesive is placed on the glass fiber weave. As previously mentioned, the adhesive may come in a variety of forms and states, including liquid, solid, particulate, and so forth. The adhesive is generally directly applied to the surface of the weave that will face the polymer sheet, but may alternately be applied to the polymer sheet's surface that will face the weave. Further, alternate embodiments may coat or apply adhesive to both sides of the weave, if a two-side laminate is desired. Alternately, the adhesive may be omitted and this step skipped.

The polymer sheet is added in the next step. Typically, the sheet is laid atop, affixed to, or otherwise placed on the surface of the weave having adhesive. If no adhesive is added (i.e., if the resin stop is omitted), the polymer is generally placed directly on the weave. Further, the polymer chosen to manufacture the sheet is generally one with a relatively low melting point. The polymer sheet may be pressed against the weave by rollers to facilitate a uniform placement of the two and minimize any discontinuities.

In the next step, the precursor product is heated to a melting point. If the precursor product includes an adhesive, the melting point is at least that of the adhesive. As the melting point is reached, the adhesive melts and flows along the top surface of the weave and bottom surface of the polymer sheet, bonding the two together. In some embodiments, the melting point may be raised to at least partially melt the polymer sheet, thus causing the polymer to at least partially encapsulate at least some of the fiberglass yarns. This may increase the bond between the polymer sheet and the weave or scrim, and may at least partially fill some void spaces.

Because the polymer sheet is bonded to the weave via heating or adhesive, it should be noted that the product need not be dipped or coated with any chemicals or other liquid surface agents. Accordingly, such bonding methods are often referred to as “dry-lay” bonding methods, because weave or scrim and the polymer sheet are dry throughout the bonding process.

If no adhesive is included, the melting point is at least that of the polymer sheet. The polymer (typically a polyester, such as polyolefin or polypropylene, or a polyurethane) may melt and flow around the yarns of the weave, as described above. Further, capillary action may generally draw the polymer into the void spaces between yarns, substantially filling the spaces and creating a uniformly smooth product, with few or no holes or surface discontinuities. When the void spaces are filled with polymer, the finished product is generally smooth along both the top and bottom surfaces.

In the final step, the product is cooled and cut. The product may be cold-cut without the yarns fraying or unraveling, and without the scrim falling apart. The product may be cut to any size and/or shape desired.

7. Conclusion

Although the invention has been described above with reference to specific embodiments and processes (for example, methods of manufacture), it should be understood these embodiments and processes are intended as examples of the invention, rather than limitations of or on the invention. Many additional embodiments and processes, other than those described herein, may become apparent to one of ordinary skill in the art upon reading this disclosure without departing from the spirit or scope of the invention. For example, various coatings may be used to impart different properties to the finished weave. Accordingly, the proper scope of the invention is defined by the appended claims.

I claim:

1. A flexible, laminated woven product, comprising:
a first fiber yarn;
a second fiber yarn bonded to the first fiber yarn; and
a polymer dry-lay bonded to a top surface of at least one of the first and second fiber yarns.

2. The product of claim 1, further comprising an adhesive between the polymer and at least one of first and second fiber yarns, the adhesive operative to bond the polymer to the yarn.

3. The product of claim 1, wherein the first and second fiber yarns are fiberglass.

4. The product of claim 3, wherein the first and second fiber yarns at least partially define void spaces therebetween; and wherein
the polymer at least partially fills the void spaces.

5. The product of claim 4, wherein the polymer substantially fills the void spaces; and
wherein the first and second fiber yarns each have top and bottom surfaces and wherein the polymer coats both the top and bottom surface of at least one of the first and second fiber yarns.

6. The product of claim 1, wherein the dry-lay bond is a heat bond.

7. The product of claim 1, wherein the yarn comprises a material chosen from the group of: carbon, KEVLAR, polyester, cotton, and fiberglass.

8. The product of claim 1, wherein the first and second fiber yarns each have top and bottom surfaces and further comprising a second polymer sheet dry-lay bonded to the bottom surface of at least one of the first and second yarns.

9. The product of claim 1, wherein the polymer sheet comprises an patterned material interspersed in a polymer.

10. The product of claim 9, wherein the patterned material comprises woven fibers.

11. The product of claim 1, wherein the polymer sheet comprises from sixteen to twenty-six grams per square inch of thermoplastic.

12. A method for producing a flexible laminated woven product, comprising:
placing a polymer sheet on a first surface of a flexible weave, the flexible weave comprising at least one yarn;
heating the combination of polymer sheet and flexible weave to a melting point;
in response to heating the combination of polymer sheet and flexible weave to a melting point, bonding the polymer sheet to the flexible weave to form a flexible laminated weave; and
cooling the flexible laminated weave.

13. The method of claim 12, further comprising cutting the flexible laminated weave without fraying or unraveling the yarn.

14. The method of claim 13, wherein the melting point is the melting point of the polymer sheet.

15. The method of claim 14, wherein the step of bonding the polymer sheet to the flexible weave comprises encapsulating the yarn with the polymer.

16. The method of claim 15, wherein the weave includes void spaces and further comprising the step of completely filling the void spaces with the polymer.

17. The method of claim 16, wherein the step of completely filling the void spaces comprises the steps of:
creating a capillary action to draw the polymer into the void spaces; and
cooling the polymer.

18. The method of claim 12, further comprising the step of adding an adhesive between the polymer sheet and the flexible weave; and wherein
the melting point is the melting point of the adhesive; and
the step of bonding the polymer sheet to the flexible weave comprises bonding the polymer sheet to the flexible weave with the adhesive.

19. The method of claim 12, further comprising the step of adding a coating to the flexible weave.

20. The method of claim 19, wherein the yarn is fiberglass.
